(19) United States
(12) Patent Application Publication
(10) Pub. No.: US 2024/0047191 A1
(43) Pub. Date: Feb. 8, 2024

(54) MASS AND/OR ION MOBILITY SPECTROMETRY

(71) Applicant: Micromass UK Limited, Wilmslow (GB)

(72) Inventors: Jason Wildgoose, Wilmslow (GB); Martin Green, Wilmslow (GB); David Langridge, Wilmslow (GB); Kevin Giles, Wilmslow (GB); Jakub Ujma, Wilmslow (GB)

(73) Assignee: Micromass UK Limited, Wilmslow (GB)

(21) Appl. No.: 18/259,015

(22) PCT Filed: Dec. 23, 2021
(86) PCT No.: PCT/GB2021/053427

§ 371 Date: Jun. 22, 2023

(30) Foreign Application Priority Data
Dec. 24, 2020 (GB) 2020575.3
May 13, 2021 (GB) 2106850.7
May 26, 2021 (GB) 2107491.9

(51) Int. Cl. H01J 49/40; G01N 27/623; H01J 49/02; H01J 49/00

(52) U.S. Cl. CPC H01J 49/403; G01N 27/623; H01J 49/025; H01J 49/005

(57) ABSTRACT

A method of analysing ions comprises separating ions according to a first physico-chemical property by passing the ions through an ion separation device, and measuring the transit time of an ion through the ion separation device. The method further comprises detecting the ion using a charge-resolving ion detector so as to determine the charge of the ion, and using the transit time and the charge of the ion to determine a second physico-chemical property of the ion.

### CROSS-REFERENCE TO RELATED APPLICATION

This application claims priority from and the benefit of United Kingdom patent application No. 2020575.3 filed 24 Dec. 2020 and United Kingdom patent application No. 2106850.7 filed 13 May 2021. The entire content of these applications is incorporated herein by reference.

### FIELD OF THE INVENTION

The present invention relates generally to methods of analysing particles and/or ions, and in particular to methods of analysing particles and/or ions using mass and/or ion mobility spectrometry.

### BACKGROUND

Charge detection mass spectrometry (CDMS) is becoming a popular method of mass spectrometry for highly charged species, as the technique employs approaches that allow ions with similar or the same mass to charge ratios (m/z) but different charges (z) to be separated, ultimately improving the resolution and mass measurement of mass spectra.

These approaches typically use ion trapping techniques to simultaneously measure mass to charge ratio (m/z) and charge (z). However, these approaches are relatively slow when compared with other m/z separations, such as time of flight mass spectrometry (ToF-MS). The speed is further compromised by the restriction of being limited to analysing single particles or molecules to avoid space charge effects, as well as due to overlapping signals due to trapped ions following non-unique flight paths or trajectories.

The Applicant believes that there remains scope for improvements to methods of mass spectrometry.

### SUMMARY

According to an aspect, there is provided a method of analysing ions, the method comprising:
separating ions according to a first physico-chemical property by passing the ions through an ion separation device;
measuring the transit time of an ion through the ion separation device, so as to determine a transit time of the ion;
detecting the ion using a charge-resolving ion detector so as to determine a charge of the ion; and
using the transit time and the charge of the ion to determine a second physico-chemical property of the ion.

Various embodiments are directed to a method of analysing ions in which ions are separated according to a first physico-chemical property by passing the ions through an ion separation device. For each (individual) ion of one or more of the ions, the transit time of that ion through the separation device is measured, so as to determine a transit time (i.e. “drift time”) for the ion. In addition, the ion is detected using a charge-resolving ion detector, so as to determine the charge (i.e. “charge state” or “charge number”) of the ion. The transit time and the charge of the ion are then used (e.g. combined) to determine a second physico-chemical property of the ion.

For example, where the ions are separated according to their mass to charge ratio (m/z) (i.e. where the first physico-chemical property comprises mass to charge ratio), the transit time of each ion will be related to its mass to charge ratio. Thus, by combining the transit time and the charge of the ion, the mass of the ion (or a property related to mass) can be determined.

In accordance with particular embodiments, this process is repeated for each ion of multiple ions, e.g. so to determine the second physico-chemical property (e.g. mass) of each individual ion, and the results are combined so as to produce a spectrum (e.g. a mass spectrum) for the ions under analysis.

Embodiments are particularly suitable for the analysis of particles that can produce ions with different charge states but which are relatively close in mass to charge ratio (m/z). This can often be the case for high-mass particles (which are usually highly charged), e.g. having a mass>1 MDa.

Conventionally, to derive the mass of such particles, the different charge states must be resolvable in mass to charge ratio (m/z). However, this can require high resolution (and therefore expensive) instrumentation. Sample heterogeneity and/or adducting can also render the different charge states unresolvable. Although charge detection mass spectrometry (CDMS) approaches can be used to separate such highly charged ions, as described above these approaches can be relatively slow.

Various embodiments exploit the inherent speed of separation-based approaches (such as, e.g. time of flight (ToF) mass spectrometry). Moreover, embodiments utilise the charge state resolution provided by the charge-resolving ion detector (in addition to the e.g. mass to charge ratio (m/z) resolution of the separation device) to resolve ions e.g. with similar or the same mass to charge ratio (m/z) but different charges (z).

This facilitates increased resolution in the ultimate spectrum (e.g. mass spectrum), without necessitating high resolution instrumentation, nor the use of slower approaches such as charge detection mass spectrometry (CDMS). The approach of various embodiments is orders of magnitude faster than CDMS approaches.

It will be appreciated, therefore, that various embodiments provide an improved method of analysing ions.

The method may comprise ionising particles to as to produce the ions.

The particles, the ions and/or the ion may (each) have a mass>1 MDa.

The first physico-chemical property may comprise mass to charge ratio (m/z) or ion mobility.

Where the first physico-chemical property comprises mass to charge ratio (m/z), the ion separation device may comprise a time of flight (ToF) separation device configured to separate ions according to their mass to charge ratio. For example, the ion separation device may comprise a time of flight (ToF) mass analyser.

Alternatively, the ion separation device may comprise an ion separation device in which one or more time-varying electric fields is used to urge ions through a gas such that ions are separated according to mass to charge ratio.

For example, the ion separation device may be a travelling wave separation device. The method may comprise successively applying one or more voltages to different electrodes of the ion separation device so as to form one or more travelling potential barriers that move along the ion separation device so as to urge ions through the gas.

Where the first physico-chemical property comprises ion mobility, the ion separation device may comprise an ion mobility separation device configured to separate ions according to their ion mobility.

The step of measuring the transit time of the ion through the ion separation device may comprise using the charge-resolving ion detector to measure the transit time of the ion.

In these embodiments, the charge-resolving ion detector may comprise (i) a faraday cup or cylinder electrode detector; (ii) an electron multiplier detector; (iii) a photomultiplier or scintillation counter detector; and/or (iv) a superconducting tunnel junction (STJ) detector. The method may comprise determining the charge of the ion from the intensity, amplitude and/or area of a signal generated by the charge-resolving ion detector when the ion is detected.

Alternatively, the step of measuring the transit time of the ion through the ion separation device may comprise using a second (different) ion detector to measure the transit time of the ion. Thus, the (each) ion may be detected by a first charge-resolving ion detector so as to determine the charge of the ion, and a second different ion detector so as to determine the transit time of the ion.

In these embodiments, the charge-resolving ion detector may comprise any suitable (non-destructive) charge-resolving ion detector that is configured to measure the charge of an ion. For example, the charge-resolving ion detector may comprise an induction charge detector such as and induction plate or an induction tube.

The second ion detector may comprise (i) a faraday cup or cylinder electrode detector; (ii) an electron multiplier detector; (iii) a photomultiplier or scintillation counter detector; and/or (iv) a superconducting tunnel junction (STJ) detector. The charge-resolving ion detector may be arranged upstream of the second ion detector.

Using the transit time and the charge of the ion to determine a second physico-chemical property of the ion may comprise combining the transit time and the charge of the ion to determine the second physico-chemical property of the ion.

The method may comprise controlling the flux of the ions at the detector or detectors such that (some, most or all) individual ions are distinguishable from each other when detected by the detector or detectors.

The method may comprise, for each ion of multiple (individual) ions:
measuring the transit time of the ion through the ion separation device, so as to determine a transit time of the ion;
detecting the ion using the charge-resolving ion detector so as to determine a charge of the ion; and
using the transit time and the charge of the ion to determine the second physico-chemical property of the ion.

The method may further comprise: combining the determined second physico-chemical property of each ion of the multiple ions so as to produce a spectrum for the ions.

The second physico-chemical property may comprise mass, or collision or reaction cross section. Thus, the spectrum may comprise a mass spectrum or a collision or reaction cross section spectrum.

The method may comprise reducing the charge of the ions before separating the ions.

According to an aspect, there is provided an analytical instrument comprising:
an ion separation device, wherein the ion separation device is configured to separate ions according to a first physico-chemical property when the ions are passed through the ion separation device; and
an ion detector arranged downstream of the ion separation device, wherein the analytical instrument is configured such that ions eluting from the ion separation device can be detected by the ion detector;
wherein the analytical instrument is configured to measure the transit time of an ion passing through the ion separation device, so as to determine a transit time of the ion;
wherein the ion detector comprises a charge-resolving ion detector configured to determine the charge of the ion; and
wherein the analytical instrument is configured to use the transit time and the charge of the ion to determine a second physico-chemical property of the ion.

The analytical instrument may comprise an ion source configured to ionise particles so as to produce the ions.

The particles, the ions and/or the ion may (each) have a mass>1 MDa.

The first physico-chemical property may comprise mass to charge ratio (m/z) or ion mobility.

Where the first physico-chemical property comprises mass to charge ratio (m/z), the ion separation device may comprise a time of flight (ToF) separation device configured to separate ions according to their mass to charge. For example, the ion separation device may comprise a time of flight (ToF) mass analyser.

Alternatively, the ion separation device may comprise an ion separation device in which one or more time-varying electric fields is used to urge ions through a gas such that ions are separated according to mass to charge ratio. For example, the ion separation device may be a travelling wave separation device.

The analytical instrument may be configured to successively apply one or more voltages to different electrodes of the ion separation device so as to form one or more travelling potential barriers that move along the device so as to urge ions through the gas.

Where the first physico-chemical property comprises ion mobility, the ion separation device may comprise an ion mobility separation device configured to separate ions according to their ion mobility.

The analytical instrument may be configured to use the charge-resolving ion detector to measure the transit time of the ion passing through the ion separation device.

In these embodiments, the charge-resolving ion detector may comprise (i) a faraday cup or cylinder electrode detector; (ii) an electron multiplier detector; (iii) a photomultiplier or scintillation counter detector; and/or (iv) a superconducting tunnel junction (STJ) detector. The analytical instrument may be configured to determine the charge of the ion from the intensity, amplitude and/or area of a signal generated by the charge-resolving ion detector when the ion is detected.

Alternatively, the analytical instrument may comprise a second ion detector, and the analytical instrument may be configured to measure the transit time of the ion passing through the ion separation device using the second ion detector. Thus, the analytical instrument may be configured to use a first charge-resolving ion detector to determine the charge of the (each) ion, and a second different ion detector to determine the transit time of the (each) ion.

In these embodiments, the charge-resolving ion detector may comprise any suitable (non-destructive) charge-resolving ion detector that is configured to measure the charge of an ion. For example, the charge-resolving ion detector may comprise an induction charge detector such as and induction plate or an induction tube.

The second ion detector may comprise (i) a faraday cup or cylinder electrode detector; (ii) an electron multiplier detector; (iii) a photomultiplier or scintillation counter detector; and/or (iv) a superconducting tunnel junction (STJ) detector. The charge-resolving ion detector may be arranged upstream of the second ion detector.

The analytical instrument may be configured to combine the transit time and the charge of the ion to determine the second physico-chemical property of the ion.

The analytical instrument may be configured to control the flux of the ions at the detector or detectors such that (some, most or all) individual ions are distinguishable from each other when detected by the detector or detectors.

The analytical instrument may be configured to:
for each ion of multiple (individual) ions:
   measure the transit time of the ion through the ion separation device, so as to determine a transit time of the ion;
   detect the ion using the charge-resolving ion detector so as to determine a charge of the ion; and
   use the transit time and the charge of the ion to determine the second physico-chemical property of the ion.

The analytical instrument may be further configured to: combine the determined second physico-chemical property of each ion of the multiple ions so as to produce a spectrum for the ions.

The second physico-chemical property may comprise mass or collision or reaction cross section. Thus, the spectrum may comprise a mass spectrum or a collision or reaction cross section spectrum.

The analytical instrument may comprise one or more devices configured to reduce the charge of the ions, which may be arranged upstream of the ion separation device.

According to an aspect, there is provided a method of analysing ions, the method comprising:
detecting an ion using an induction charge detector;
determining a charge of the ion from a signal generated by the induction charge detector when the ion is detected;
determining a transit time of the ion from the signal generated by the induction charge detector when the ion is detected; and
using the transit time and the charge of the ion to determine a (second) physico-chemical property of the ion.

According to an aspect, there is provided an analytical instrument comprising:
an induction charge detector configured to detect ions;
wherein the analytical instrument is configured to:
determine a charge of an ion from a signal generated by the induction charge detector when the ion is detected;
determine a transit time of the ion from the signal generated by the induction charge detector when the ion is detected; and
use the transit time and the charge of the ion to determine a (second) physico-chemical property of the ion.

These aspects can, and in various embodiments do, include any one or more or each of the optional features described elsewhere herein.

For example, the method may comprise:
for each ion of multiple ions:
   detecting the ion using the induction charge detector;
   determining a charge of the ion from a signal generated by the induction charge detector when the ion is detected;
   determining a transit time of the ion from the signal generated by the induction charge detector when the ion is detected; and
   using the transit time and the charge of the ion to determine a (second) physico-chemical property of the ion; and
combining the determined second physico-chemical property of each ion of the multiple ions so as to produce a spectrum for the ions.

The second physico-chemical property may comprise (i) mass or (ii) collision or reaction cross section.

According to an aspect, there is provided a method of analysing ions, the method comprising:
isolating an ion that has a first value of a first physico-chemical property by passing ions through an ion filtering device;
detecting the ion using a charge-resolving ion detector so as to determine a charge of the ion; and
using the first value of the first physico-chemical property and the charge of the ion to determine a second physico-chemical property of the ion.

According to an aspect, there is provided an analytical instrument comprising:
an ion filtering device, wherein the a ion filtering device is configured to filter ions according to a first physico-chemical property when ions are passed through the ion separation device; and
an ion detector arranged downstream of the ion filtering device, wherein the analytical instrument is configured such that ions eluting from the ion filtering device can be detected by the ion detector;
wherein the analytical instrument is configured to isolate an ion that has a first value of the first physico-chemical property by passing ions through the ion filtering device;
wherein the ion detector comprises a charge-resolving ion detector configured to determine the charge of the ion; and
wherein the analytical instrument is configured to use the first value of the first physico-chemical property and the charge of the ion to determine a second physico-chemical property of the ion.

These aspects can, and in various embodiments do, include any one or more or each of the optional features described elsewhere herein.

For example, the method may comprise:
isolating ions having different values of the first physico-chemical property by passing ions through the ion filtering device, optionally while varying (e.g. scanning) a (first physico-chemical property) transmission window of the ion filtering device; and
for each ion of multiple ions:
   detecting the ion using a charge-resolving ion detector so as to determine a charge of the ion; and
   using the value of the first physico-chemical property of the ion and the charge of the ion to determine a second physico-chemical property of the ion; and
combining the determined second physico-chemical property of each ion of the multiple ions so as to produce a spectrum for the ions.

The first physico-chemical property may comprise mass to charge ratio (m/z). The second physico-chemical property may comprise mass.

The ion filtering device may comprising a quadrupole mass filter.

According to an aspect, there is provided a method of mass spectrometry comprising:
separating a population of ions in time where the time is related to two or more physico-chemical properties, and where one of the physico-chemical properties is number of charges;
detecting ions using a detector that has a response that is a function of the charge state of ions detected;
controlling the ion flux at the detector so that responses of individual ions are distinguishable from each other and measurable; and
processing the detector signal each separation cycle so as to produce a spectrum based on one or more physicochemical properties other than charge state.

### BRIEF DESCRIPTION OF THE DRAWINGS

Various embodiments will now be described, by way of example only, and with reference to the accompanying drawings in which:

FIG. 1 shows schematically an analytical instrument configured in accordance with embodiments;

FIG. 2 shows the percentage reduction in average particle velocity as a function of a and y for a one-dimensional smoothly moving travelling wave devices;

FIG. 3 shows schematically an analytical instrument configured in accordance with embodiments;

FIG. 4 shows schematically an analytical instrument configured in accordance with embodiments;

FIG. 5 shows schematically an analytical instrument configured in accordance with embodiments; and

FIG. 6 shows simulated data from a simple listening tube.

### DETAILED DESCRIPTION

CDMS is becoming a popular method of mass spectrometry for highly charged species, as the technique employs approaches that allow ions with similar or the same mass to charge ratio (m/z) but different charges (z) to be separated, ultimately improving the resolution and mass measurement of mass spectra.

These approaches typically use ion trapping techniques to simultaneously measure m/z and z. However, these approaches are relatively slow when compared with other m/z separations such as time of flight mass spectrometry (ToF-MS). The speed is further compromised by the restriction of being limited to analysing single particles and/or molecules to avoid space charge effects as well as overlapping signals due to trapped ions following non-unique flight paths and/or trajectories.

Various embodiments are directed to a method of analysing ions in which ions are separated according to a first physico-chemical property by passing the ions through an ion separation device. For each (individual) ion of one or more of the ions, the transit time of that ion through the separation device is measured, so as to determine a transit time (i.e. “drift time”) for the ion. In addition, the ion is detected using a charge-resolving ion detector, so as to determine the charge (i.e. “charge state” or “charge number”) of the ion. The transit time and the charge of the ion are then used (e.g. combined) to determine a second physico-chemical property of the ion.

For example, where the ions are separated according to their mass to charge ratio (m/z) (i.e. where the first physico-chemical property comprises mass to charge ratio), the transit time of each ion will be related to its mass to charge ratio. Thus, by combining the transit time and the charge of the ion, the mass (or a property related to mass) of the ion can be determined.

Where the ions are separated according to their ion mobility (i.e. where the first physico-chemical property comprises ion mobility), the transit time of each ion will be related to its ion mobility. By combining the transit time and the charge of the ion, the collision or reaction cross section (or a property related to collision or reaction cross section) of the ion can be determined.

In accordance with particular embodiments, this process is repeated for each ion of multiple ions, e.g. so to determine the second physico-chemical property (e.g. mass) of each individual ion, and the results are combined so as to produce a spectrum (e.g. a mass spectrum) for the ions under analysis. To facilitate this, the flux of the ions at the detector or detectors may be controlled such that (some, most or all) individual ions are distinguishable from each other when detected by the detector or detectors.

Embodiments are particularly suitable for the analysis of particles that can produce ions with different charge states but which are relatively close in mass to charge ratio (m/z). This can often be the case for high-mass particles (which are usually highly charged), e.g. having a mass>1 MDa.

Conventionally, to derive the mass of such particles, the different charge states must be resolvable in mass to charge ratio (m/z). However, this can require high resolution (and therefore expensive) instrumentation. Sample heterogeneity and/or adducting can also render the different charge states unresolvable. Although charge detection mass spectrometry (CDMS) approaches can be used to separate such highly charged ions, as described above these approaches can be relatively slow.

Various embodiments exploit the inherent speed of separation-based approaches (such as, e.g. time of flight (ToF) mass spectrometry). Moreover, embodiments utilise the charge state resolution provided by the charge-resolving ion detector (in addition to the e.g. mass to charge ratio (m/z) resolution of the separation device) to resolve ions e.g. with similar or the same mass to charge ratio (m/z) but different charges (z).

This facilitates increased resolution in the ultimate spectrum (e.g. mass spectrum), without necessitating high resolution instrumentation, nor the use of slower approaches such as charge detection mass spectrometry (CDMS). The approach of various embodiments is orders of magnitude faster than CDMS approaches.

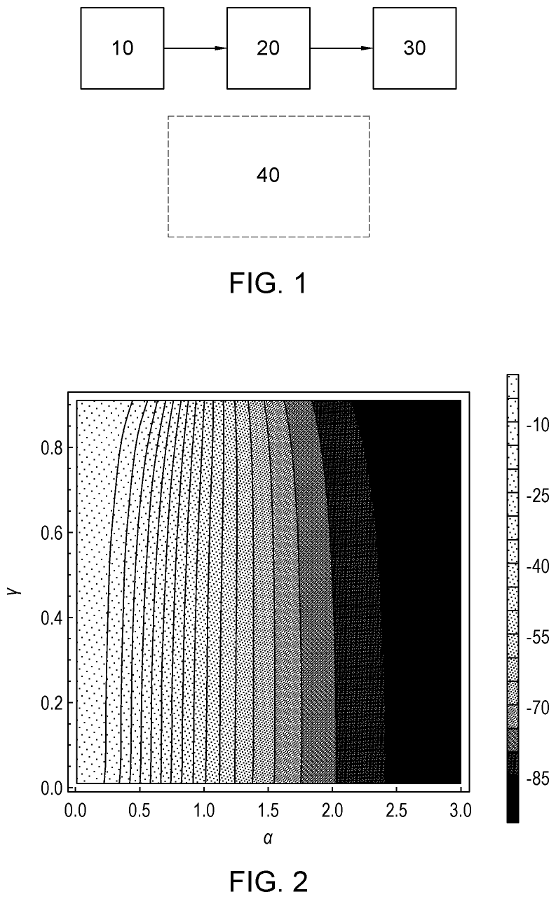

FIG. 1 shows schematically an analytical instrument in the form of a mass and/or ion mobility spectrometer in accordance with embodiments.

As shown in FIG. 1, the analytical instrument comprises an ion source 10, an ion separation device 20 arranged downstream from the ion source 10, and a detector 30 that is arranged downstream from the ion source 10 and downstream from the ion separation device 20. As illustrated by FIG. 1 the analytical instrument may be configured such that ions can be provided by (sent from) the ion source 10 to the analyser 30 via the ion separation device 20.

As also shown in FIG. 1, the analytical instrument may comprise a control system 40 that is configured to control the operation of the analytical instrument, for example in the manner of the various embodiments described herein. The control system may comprise suitable control circuitry that is configured to cause the instrument to operate in the manner of the various embodiments described herein. The control system may comprise suitable processing circuitry configured to perform any one or more or all of the necessary processing and/or post-processing operations in respect of the various embodiments described herein. The control system may comprise one or more of a suitable computing device, a microprocessor system, a programmable FPGA (field programmable gate array), and the like.

The ion source 10 is configured to ionise particles so as to produce ions.

The particles may be high-mass particles, e.g. where each particle has a mass>1 MDa. Equally, the ions may each have a mass>1 MDa. Such high-mass particles (which are usually highly charged) can often produce ions with different charge states but which are relatively close in mass to charge ratio (m/z).

High mass particles can include any high mass particles, such as for example viruses, capsids, nanoparticles such as nanoparticles comprising surface active molecules (e.g. vesicles, nano-discs), lipoprotein particles (e.g. cholesterol), polyoxo-metallates and other supramolecular constructs, metal clusters, polymer chains, and the like.

The ion source 10 may comprise any suitable ion source, such as an ambient ionisation ion source, that is, an ion source configured to ionise the particles at ambient or atmospheric pressure.

The ion source 10 may be an ion source selected from the group consisting of: (i) an Electrospray ionisation (“ESI”) ion source; (ii) an Atmospheric Pressure Photo Ionisation (“APPI”) ion source; (iii) an Atmospheric Pressure Chemical Ionisation (“APCI”) ion source; (iv) a Matrix Assisted Laser Desorption Ionisation (“MALDI”) ion source; (v) a Laser Desorption Ionisation (“LDI”) ion source; (vi) an Atmospheric Pressure Ionisation (“API”) ion source; (vii) a Desorption Ionisation on Silicon (“DIOS”) ion source; (viii) an Electron Impact (“EI”) ion source; (ix) a Chemical Ionisation (“CI”) ion source; (x) a Field Ionisation (“FI”) ion source; (xi) a Field Desorption (“FD”) ion source; (xii) an Inductively Coupled Plasma (“ICP”) ion source; (xiii) a Fast Atom Bombardment (“FAB”) ion source; (xiv) a Liquid Secondary Ion Mass Spectrometry (“LSIMS”) ion source; (xv) a Desorption Electrospray Ionisation (“DESI”) ion source; (xvi) a Nickel-63 radioactive ion source; (xvii) an Atmospheric Pressure Matrix Assisted Laser Desorption Ionisation ion source; (xviii) a Thermospray ion source; (xix) an Atmospheric Sampling Glow Discharge Ionisation (“ASGDI”) ion source; (xx) a Glow Discharge (“GD”) ion source; (xxi) an Impactor ion source; (xxii) a Direct Analysis in Real Time (“DART”) ion source; (xxiii) a Laserspray Ionisation (“LSI”) ion source; (xxiv) a Sonicspray Ionisation (“SSI”) ion source; (xxv) a Matrix Assisted Inlet Ionisation (“MAII”) ion source; (xxvi) a Solvent Assisted Inlet Ionisation (“SAII”) ion source; (xxvii) a Laser Ablation Electrospray Ionisation (“LAESI”) ion source; (xxviii) a Surface Assisted Laser Desorption Ionisation (“SALDI”) ion source; (xxix) a Low Temperature Plasma (“LTP”) ion source; (xxxi a Helium Plasma Ionisation (“HePI”) ion source; (xxxi) a Rapid Evaporative Ionisation Mass Spectrometry (“REIMS”) ion source; and/or (xxxii) a Laser Assisted Rapid Evaporative Ionisation Mass Spectrometry (“LA-REIMS”) ion source.

In particular embodiments, the ion source 10 is an electrospray ionisation (ESI) ion source.

The analytical instrument may optionally comprise a chromatography or other separation device (not shown in FIG. 1) upstream of (and coupled to) the ion source 10. The chromatography separation device may comprise a liquid chromatography or gas chromatography device. Alternatively, the separation device may comprise: (i) a Capillary Electrophoresis (“CE”) separation device; (ii) a Capillary Electrochromatography (“CEC”) separation device; (iii) a substantially rigid ceramic-based multilayer microfluidic substrate (“ceramic tile”) separation device; or (iv) a supercritical fluid chromatography separation device.

The ion separation device 20 is configured to receive ions from the ion source 10 (optionally via one or more ion guides or other ion optical elements), separate the ions according to a first physico-chemical property, and then pass the separated ions to the detector 30 for detection (optionally via one or more ion guides or other ion optical elements). Ions may be separated within the ion separation device 20 as they travel through the ion separation device 20.

Ions may be separated according to the first physico-chemical property such that ions having different values of the first physico-chemical property arrive at an exit region of the ion separation device 20 at different times, for example such that ions with relatively high values of the first physico-chemical property arrive at the exit region ahead of ions with relatively low values of the first physico-chemical property (or such that ions with relatively low values of the first physico-chemical property arrive at the exit region ahead of ions with relatively high values of the first physico-chemical property).

This means that the transit time of an ion through the ion separation device 20 will be related to that ion's value of the first physico-chemical property. Thus, by measuring the transit time of an ion through the ion separation device 20, the ion's particular value of the first physico-chemical property can be determined.

The ion separation device 20 may comprise any suitable device configured to (temporally) separate ions according to the first physico-chemical property. Equally, the first physico-chemical property may comprise any suitable physico-chemical property. In particular embodiments, the first physico-chemical property is (i) mass to charge ratio (m/z), or (ii) ion mobility collision or reaction cross section.

Where the first physico-chemical property comprises mass to charge ratio (m/z), the ion separation device 20 may comprise a time of flight (ToF) separation device, such as a time of flight (ToF) mass analyser, configured to separate ions according to their mass to charge ratio (m/z).

In these embodiments, the mass analyser may comprise an acceleration (pusher) electrode, an acceleration region, and a field free or drift region (e.g. in the form of a “drift tube”). The mass analyser may also comprise a (pusher) drive unit and circuitry configured to supply electrical pulses generated by the drive unit to the acceleration (pusher) electrode of the mass analyser.

Ions from the ion source 10 may be arranged to enter the acceleration region where they may be driven into the field free or drift region by application of an electrical pulse (generated by the (pusher) drive unit) to the acceleration (pusher) electrode. Thus, the time of flight (ToF) mass analyser may be configured to cause ions to be accelerated into the field free or drift region as a result of an electrical pulse being supplied to the acceleration electrode.

The ions may be accelerated to a velocity determined by the energy imparted by the pulse and the mass to charge ratio (m/z) of the ions. Ions having a relatively low mass to charge ratio will achieve a relatively high velocity and reach the exit of the field free or drift region prior to ions having a relatively high mass to charge ratio. Thus, ions may arrive at the exit of the field free or drift region after a transit time determined by their velocity and the distance travelled, which enables the mass to charge ratio of the ions to be determined.

Thus, ions may be separated according to their mass to charge ratio (m/z), and a transit time of a (each) ion through the ion separation device may be measured so as to determine the transit time of the ion (which transmit time may be related to the mass to charge ratio of the ion).

In these embodiments, the (drift tube of the) ion separation device 20 may be maintained at a relatively low pressure, such as a pressure of around (i) <0.00001 mbar; (ii) 0.00001-0.0001 mbar; (iii) 0.0001-0.001 mbar; (iv) 0.001-0.01 mbar; or (iv) 0.01-0.1.

In various alternative embodiments, the ion separation device 20 may comprises a high pressure m/z separation device. In these embodiments, the ion separation device 20 may be configured to separate ions according to mass to charge ratio by using one or more time-varying electric fields to urge ions through a gas.

A separation region of the ion separation device 20 may be filled with a gas, such as an inert (buffer) gas, such as nitrogen. Ions may be separated within the ion separation device 20 according to their mass to charge ratio (m/z) as they pass through the gas.

The (separation region of the) ion separation device 20 may be operated (maintained) at any suitable pressure, such as (i) <0.1 mbar; (ii) 0.1-0.5 mbar; (iii) 0.5-1 mbar; (iv) 1-2 mbar; (v) 2-5 mbar; (vi) 5-10 mbar; (vii) 10-15 mbar; (viii) 15-20 mbar; (ix) 20-25 mbar; (x) 25-30 mbar; or (xi) >30 mbar. In particular embodiments, the (separation region of the) ion separation device 20 is maintained at a pressure between about 0.1 and 20 mbar. Using an ion separation device that is configured to separate ions while they pass through a (relatively high pressure) gas beneficially means that m/z separation can be achieved without requiring high vacuum pumping. Embodiments therefore provide a particularly simple and low-cost method of analysing particles, and a particularly simple and low-cost analytical instrument.

The ion separation device 20 may be configured such that one or more time-varying electric fields is used to urge ions through the gas such that ions are separated according to mass to charge ratio (m/z). In particular embodiments, the ion separation device 20 comprises a travelling wave (TVV) ion separation device.

The ion separation device 20 may comprise a plurality of electrodes, e.g. in the form of an ion guide. Electrodes of the ion guide may define an ion path along which ions are transmitted in use.

The ion separation device 20 may comprise any suitable ion guide, such as an ion guide comprising a plurality of electrodes each having an aperture through which ions are transmitted in use (such as a stacked ring (or stacked plate) ion guide), or a segmented quadrupole ion guide. A segmented quadrupole ion guide can provide a more uniform radial distribution of charge states. The ion guide may be a linear (straight) ion guide, or a closed loop or cyclic ion guide.

The ion separation device 20 may comprise one or more voltage sources configured to apply voltages to the electrodes of the ion guide. Voltages may be successively applied to the electrodes of the device 20 so as to form a wave of potential barriers that move in a first direction along the device so as to urge ions in the first direction through the gas.

Where the ion guide comprises a linear ion guide, the first direction may be an axial direction along the length of the ion guide. A travelling wave may be formed along the device 20, moving in a direction from an entrance end to an exit end of the separation device 20. The moving DC potential barrier may urge the ions through the gas towards the exit end of the separation device 20. Where the ion guide comprises a closed loop or cyclic ion guide, the first direction may be a circumferential (azimuth) direction around the circumference of the ion guide. The moving DC potential barrier may urge the ions around the ion guide one or more times.

Ions may be separated according to their mass to charge ratio such that ions having different mass to charge ratios arrive at an exit region of the ion guide at different times, for example such that ions with relatively high mass to charge ratios arrive at the exit region ahead of ions with relatively low mass to charge ratios (or such that ions with relatively low values of mass to charge ratio arrive at the exit region ahead of ions with relatively high values of mass to charge ratio).

Multiple DC potential barriers may be sequentially applied to (and travelled along or around) the separation device 20. The parameters of the DC potential may be selected such that each ion is passed by the DC travelling potentials multiple times as it travels through the separation device 20, i.e. the ion will roll over multiple DC potential barriers. This may be achieved, for example, by selecting an appropriate speed and voltage amplitude for the DC potential barrier.

In embodiments, the amplitude of each DC voltage may be around (i) <1 V; (ii) 1-10 V; (iii) 10-20 V; (iv) 20-30 V; (v) 30-40 V; (vi) 40-50 V; (vii) 50-60 V; (viii) 60-70 V; (ix) 70-80 V; (x) 80-90 V; (xi) 90-100 V; and (xii) >100 V. Each voltage may be applied to an electrode for between around 10-4 ms and 5 ms. The wave(s) may have any suitable velocity such as around (i) <50 m/s; (ii) 50-100 m/s; (iii) 100-200 m/s; (iv) 200-300 m/s; (v) 300-400 m/s; (vi) 400-500 m/s; (vii) 500-1000 m/s; (viii) 1000-1500 m/s; (ix) 1500-2000 m/s; or (x) >2000 m/s.

Travelling wave (TW) induced ion transport depends on both ion mobility and mass to charge ratio (m/z). As described, for example, in US 2020/0161119, the contents of which are incorporated herein by reference, the m/z dependence has been previously characterized in terms of velocity relaxation, which (for a chosen set of operating parameters) increases with the mass to charge ratio (m/z) of the ions. As such, operating parameters can be tailored to yield separation dominated by either m/z or mobility, or a combination of the two.

The separation characteristics of such a device are conveniently parameterized in terms of the parameters:

$$γ = 2 π \frac{{V}_{0}}{v λ} K , α = 2 π \frac{v}{λ} \frac{K m}{z} ,$$

where V₀ is the applied wave amplitude, v is the wave velocity, λ is the wavelength and K and m/z are the mobility and mass-to-charge ratio of the particle, respectively.

FIG. 2 shows the percentage reduction in average particle velocity as a function of α and γ for a one-dimensional smoothly moving travelling wave device. Qualitative behaviour in more realistic devices in which ions can move off-axis and in which waves move forward in steps rather than moving smoothly is similar, and can be characterized numerically or in simulation.

At higher values of α, the degree of velocity relaxation (and hence the dependence on m/z ratio) increases. Thus, in embodiments, the parameters of the DC potential may be selected such that ions are separated (predominantly) according to mass to charge ratio.

The applied travelling wave(s) may be smoothly moving or stepped. For stepped waves, the step size may be adjusted to optimize the relative amounts of mass to charge ratio (m/z) and ion mobility separation.

The ion separation device 20 may be operated with or without radially confining RF voltages. Where the ion separation device 20 is operated without radially confining RF voltages, the travelling wave conditions may be chosen to produce sufficient m/z separation and confinement simultaneously.

Where the ion separation device 20 is operated with radially confining RF voltages, the ion separation device 20 may comprise one or more further voltage supplies configured to supply an AC or RF voltage to the electrodes. Opposite phases of an AC or RF voltage may be applied to successive electrodes. The AC or RF voltage may have an amplitude selected from the group consisting of: (i) <50 V peak to peak; (ii) 50-100 V peak to peak; (iii) 100-150 V peak to peak; (iv) 150-200 V peak to peak; (v) 200-250 V peak to peak; (vi) 250-300 V peak to peak; (vii) 300-350 V peak to peak; (viii) 350-400 V peak to peak; (ix) 400-450 V peak to peak; (x) 450-500 V peak to peak; and (xi) >500 V peak to peak. The AC or RF voltage may have a frequency selected from the group consisting of: (i) <100 kHz; (ii) 100-200 kHz; (iii) 200-300 kHz; (iv) 300-400 kHz; (v) 400-500 kHz; (vi) 0.5-1.0 MHz; (vii) 1.0-1.5 MHz; (viii) 1.5-2.0 MHz; (ix) 2.0-2.5 MHz; (x) 2.5-3.0 MHz; (xi) 3.0-3.5 MHz; (xii) 3.5-4.0 MHz; (xiii) 4.0-4.5 MHz; (xiv) 4.5-5.0 MHz; (xv) 5.0-5.5 MHz; (xvi) 5.5-6.0 MHz; (xvii) 6.0-6.5 MHz; (xviii) 6.5-7.0 MHz; (xix) 7.0-7.5 MHz; (xx)7.5-8.0 MHz; (xxi) 8.0-8.5 MHz; (xxii) 8.5-9.0 MHz; (xxiii) 9.0-9.5 MHz; (xxiv) 9.5-10.0 MHz; and (xxv) >10.0 MHz.

The ion separation device 20 may be configured to (receive and) separate packets (groups) of ions. Where the ion source 10 comprises a pulsed ion source, packets of ions may be generated by the ion source 10.

However, in particular embodiments (where the ion source 10 is either a pulsed or continuous ion source), the analytical instrument furthers comprises an ion trap (not shown in FIG. 1), which may be arranged between the ion source 10 and the ion separation device 20. Ions generated by the ion source 10 may be accumulated in the ion trap, and the ion trap may be configured to pass packets of ions to the ion separation device 20, such as by periodically passing a packet of ions to the ion separation device 20. Each packet of ions may comprise ions of the mixture of particles to be analysed.

The ion trap may comprise any suitable ion trap, such as for example (i) a 2D or linear quadrupole ion trap; (ii) a Paul or 3D quadrupole ion trap; (iii) a Penning ion trap; (iv) a stacked ring ion trap; or (v) another type of ion trap.

Thus, particular embodiments employ a gas-filled ion separation device 20 for mass to charge ratio separation, where a travelling voltage wave (TVV) propels ions along the device 20. The device 20 may be implemented between an ion source 10 (for example an electrospray ionisation (ESI) ion source) and a detector 30. Ions may be delivered to the TW device 20 in packets for subsequent separation. The TW device 20 may be operated under conditions such that substantially temporal m/z separation is achieved during ion propulsion through the gas. The ions may be subsequently detected.

This arrangement does not require high vacuum stages or conventional mass analysers. The ion separation device 20 of various embodiments beneficially requires relatively low voltages, and does not require precise control of those voltages. Embodiments therefore provide a particularly simple and low-cost method of analysing particles, and a particularly simple and low-cost analytical instrument.

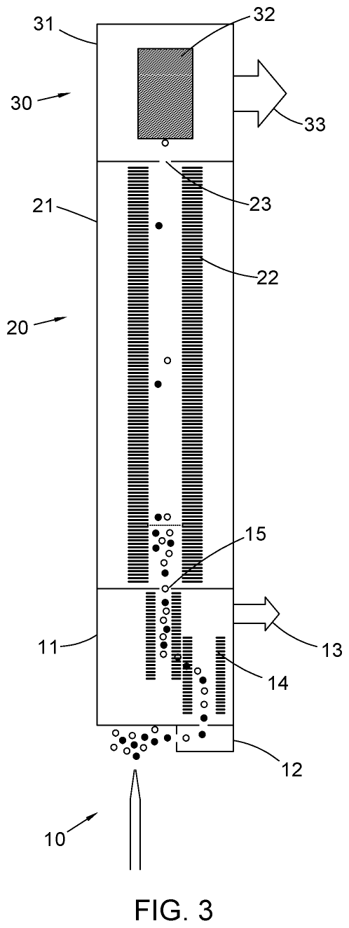

FIG. 3 shows schematically an analytical instrument in the form of a mass and/or ion mobility spectrometer in accordance with these embodiments. As shown in FIG. 3, the instrument may comprise an ambient ion source 10 in the form of a nano-ESI ion source. Ions generated by the ion source 10 may be sampled into an initial vacuum chamber 11 of the instrument via an atmospheric pressure interface 12.

The initial vacuum chamber 11 may be operated (maintained) at any suitable pressure, such as (i) <1 mbar; (ii) 1-2 mbar; (iii) 2-5 mbar; (iv) 5-10 mbar; (v) 10-15 mbar; (vi) 15-20 mbar; (vii) 20-25 mbar; (viii) 25-30 mbar; or (ix) >30 mbar. In particular embodiments, the initial vacuum chamber 11 is maintained at a pressure between about 1 and 20 mbar. To do this, as shown in FIG. 3, the initial vacuum chamber 11 may be pumped by a backing pump (roughing pump) 13.

As also shown in FIG. 3, one or more ion guides or other ion optical elements 14, e.g. in the form of a dual conjoined ion guide, are provided in the initial vacuum chamber 11, where the one or more ion guides or other ion optical elements 14 are configured to transfer ions received from the atmospheric pressure interface 12 to (and through) an aperture 15 arranged between the initial vacuum chamber 11 and a second vacuum chamber 21 of the analytical instrument.

In the embodiment depicted in FIG. 3, the ion separation device 20 is a travelling wave (TW) ion separation device, which (as described above) comprises a plurality of electrodes in the form of an ion guide 22. The ion guide 22 may be arranged within the second vacuum chamber 22, and the second vacuum chamber 21 may be maintained at a pressure between about 0.1 and 20 mbar.

Once separated by the ion separation device 20, ions are passed to the detector 30 via a second aperture 23 arranged between the second vacuum chamber 21 and a third vacuum chamber 31 of the analytical instrument.

The third vacuum chamber houses (at least) a detection surface 32 of the detector 30, and may be maintained at a pressure of around 0.0001 mbar. To do this, as shown in FIG. 3, the initial third chamber 31 may be pumped by a turbomolecular pump 33.

In various further embodiments, (as described above) the first physico-chemical property is ion mobility. In these embodiments, the ion separation device 20 may comprise an ion mobility separator configured to separate ions according to their ion mobility.

The ion mobility separator may comprise a drift tube that may be pressurised with gas. An electric field, for example comprising a DC voltage gradient and/or a travelling DC voltage wave, may be arranged to urge ions along the length of the ion mobility separator, that is through the gas, so that ions separate according to their ion mobility. The ions may optionally be urged against a counter flow of gas.

Alternatively, a gas flow may be arranged to urge ions along the length of the ion mobility separator, while an electric field, for example comprising a DC voltage gradient and/or a travelling DC voltage wave, may be arranged to oppose the gas flow so that ions separate according to their ion mobility.

The ion mobility separator may operate in-line with the ion optical path of the analytical instrument. For example, in particular embodiments, the ion mobility separator may be configured substantially in accordance with the mass to charge ratio separator described above and shown in FIG. 3, except that the separator 20 (e.g. TW device 20) may be operated under conditions such that substantially temporal ion mobility separation is achieved during ion propulsion through the gas.

Alternatively, the ion mobility separator may comprise a cyclic (closed-loop) ion separator. The ion mobility separation device may include any or all of the features of the ion separation devices disclosed in U.S. Pat. No. 9,984,861, entitled “Ion Entry/Exit Device”, in the name of Micromass UK Limited, the entire contents of which is incorporated herein by reference. Using a cyclic ion mobility separator can allow a higher degree of separation, and so higher ion mobility resolution.

Returning to FIG. 1, the detector 30 is configured to detect ions received from the ion separation device 20. The analytical instrument may be configured such that ions eluting from the ion separation device 20 are detected by the detector 30.

Ions may arrive at the ion detector 30 after a time determined by their velocity and the distance travelled. As such, the transit time may be related to the first physico-chemical property (and may enable the first physico-chemical property of the ion to be determined).

The detector 30 may be configured to output a signal from which the transit time (i.e. “drift time”) for each ion may be measured. For example, the detector 30 may be configured to detect the intensity of each ion received at the detector 30 as a function of time. Each ion arriving at the detector 30 may be sampled by the detector 30, and the signal from the detector 30 may be digitised, for example, using an ADC (analogue to digital converter).

A processor may then determine a value indicative of the transit time (e.g. time of flight) of that ion. This may use a known or measured start time together with the time at which the ion is detected. For example, where an ion gives rise to a peak having some width, a centroid or weighted average of that peak may be determined (from the digitised signal), and used as the detection time for that ion. The start time may be subtracted from the detection time so as to determine the transit time.

Thus, in various embodiments, the instrument is configured to use the detector 30 to measure the transit time (i.e. “drift time”) of each ion.

The detector 30 is a charge-resolving ion detector configured to determine the charge (i.e. “charge state” or charge number”) of each (individual) ion. The charge-resolving ion detector may be configured to output a signal from which the charge (i.e. “charge state” or charge number”) of each ion may be determined.

The charge of each ion may be determined from the same signal or from a different signal from which the transit time of that ion is measured.

Where the charge of an ion is determined using the same signal from which the transit time of the ion is determined, the charge of the ion may be determined from the intensity, amplitude and/or area of the (digitised) signal. Area can be a more precise measurement than amplitude or intensity in practice, e.g. due to the limitations of the acquisition electronics such as sampling rate and number of ADC bits.

The charge state can be determined from the area and/or intensity of a signal because the response of some detectors can vary with the charge state. For example, a Faraday cup will directly convert the amount of charge to a signal. In addition, standard ToF detectors, such as e.g. electron multipliers, have an impact energy dependent response, and the impact energy can depend on charge.

Thus, in these embodiments, the charge-resolving ion detector 30 may comprise (i) a faraday cup or cylinder electrode detector; (ii) an electron multiplier detector; (iii) a photomultiplier or scintillation counter detector; and/or (iv) a superconducting tunnel junction (STJ) detector.

Where the charge of an ion is determined using a different signal to the signal from which the transit time of the ion is determined, the analytical instrument may comprise two ion detectors. A first ion detector may be configured to determine the charge of each ion and a second detector may be configured to determine the transit time of each ion. The first ion detector may be arranged upstream of (and in proximity with) the second ion detector.

In these embodiments, the second ion detector may be configured substantially as described above, and e.g. may comprise any suitable ion detector such as, for example, (i) a faraday cup or cylinder electrode detector; (ii) an electron multiplier detector; (iii) a photomultiplier or scintillation counter detector; and/or (iv) a superconducting tunnel junction (STJ) detector.

The first, charge-resolving ion detector, may comprise any suitable charge-resolving ion detector that is configured to output a signal from which the charge of each ion can be determined. The first, charge-resolving ion detector may comprise a non-destructive charge-resolving ion detector, i.e. such that ions detected by the first ion detector will continue on to be detected by (and produce a signal on) the second detector.

The charge-resolving ion detector may comprise an induction charge detector, e.g. configured such that a passing ion will induce a charge within the detector. In particular embodiments, the charge-resolving ion detector comprises an induction plate or an induction tube.

It can also be possible to determine both the transit time of an ion and its charge using an induction charge detector. For example, the shape of the signal derived from an induction charge detector can give mass to charge ratio (m/z) information, e.g. where the difference in time between two (positive and negative) peaks is in effect a time of flight measurement, from which mass to charge ratio (m/z) can be determined.

Thus, it will be appreciated that, in accordance with embodiments, the transit time of each (individual) ion passing through the ion separation device 20 is determined, together with the charge state of that ion. The transit time (i.e. “drift time”) and the charge (i.e. “charge state” or “charge number”) for each ion are then used (e.g. combined), e.g. on an ion-by-ion basis, to determine a second physico-chemical property for each ion.

To facilitate this ion-by-ion processing, the flux of the ions at the detector or detectors may be controlled such that (some, most or all) individual ions are distinguishable from each other when detected by the detector or detectors.

Where, for example, the ions are separated according to their mass to charge ratio (m/z) (i.e. where the first physico-chemical property comprises mass to charge ratio), the transit time of each ion will be related to its mass to charge ratio. Thus, by combining the transit time and the charge of the ion, the mass (or a property related to mass) of the ion can be determined.

Where the ions are separated according to their ion mobility (i.e. where the first physico-chemical property comprises ion mobility), the transit time of each (individual) ion will be related to its ion mobility. By combining the transit time and the charge of the ion, the collision or reaction cross section (or a property related to collision or reaction cross section) of the ion can be determined.

The transit time and the charge may be combined in any suitable manner to derive the second physico-chemical property. For example, in the case of ToFMS, if the time measurement is converted to mass to charge ratio (m/z) first, then the mass to charge ratio (m/z) value may be multiplied by the charge state to get the mass (m). If however, the initial time measurement is scaled, then the time measurement would be scaled e.g. by the square root of charge, to account for the non-linear relationship between the time measurement and mass to charge ratio (m/z).

In accordance with particular embodiments, this process is repeated for each (individual) ion of multiple ions, e.g. so to determine the second physico-chemical property (e.g. mass, or collision or reaction cross section) of each individual ion, and the results are combined (e.g. summed, binned and/or histogrammed) so as to produce a spectrum (such as a mass spectrum or a collision or reaction cross section spectrum) for the ions under analysis.

Thus, in accordance with various embodiments, the transit time (i.e. “drift time”) and the charge (i.e. “charge state” or “charge number”) of each (individual) ion of multiple ions is used (e.g. combined) to determine the second physico-chemical property of each (individual) ion of the multiple ions. The so-determined second physico-chemical property of each (individual) ion of the multiple ions are then used (combined) to produce a spectrum (e.g. a mass spectrum or a collision or reaction cross section spectrum).

Embodiments exploit the inherent speed of separation-based approaches, and also utilise the charge state resolution provided by the charge-resolving ion detector (in addition to the first physico chemical property resolution of the separation device 20) to resolve ions. This can allow ions with similar or the same value of the first physico chemical property (e.g. mass to charge ratio (m/z)) but different charges (z) to be resolved in the second physico chemical property (e.g. mass), even where the ion separator 20 lacks sufficient resolution to resolve the different charge states in the first physico chemical property. For example, this can allow ions with similar or the same mass to charge ratio (m/z) but different charges (z) to be resolved, even where the ion separator 20 lacks sufficient m/z resolution to resolve the different charge states.

This facilitates increased resolution in the ultimate spectrum (e.g. mass spectrum), without necessitating high resolution instrumentation, nor the use of slower approaches such as charge detection mass spectrometry (CDMS). The approach of various embodiments is orders of magnitude faster than CDMS approaches.

It will be appreciated that various embodiments exploit the inherent speed of separation approaches like, but not limited to, time of flight mass spectrometry (ToF-MS).

Using time of flight mass spectrometry (ToF-MS) as an example, ions may enter a time of flight (ToF) mass analyser at a time determined by the electronics of the mass analyser. This start time is either measured or known. The ions separate according to m/z so that ions having different mass to charge ratios arrive at a detector at different times, where the different arrival times are measured. Typically, the data from multiple separations would be summed and/or binned into a histogram to provide a time of flight (ToF) spectrum, that may then be converted into a m/z spectrum.

However, in embodiments, the time of flight measurement for each (individual) ion is combined with the charge state of each (individual) ion, before data for multiple ions is summed and/or binned into a histogram so as to produce a final spectrum (e.g. a mass spectrum).

The charge state information for each (individual) ion may be determined based on the intensity of the signal from the same detection event that was used to measure the time of flight. Alternatively, a separate detector may be used to measure the charge state independently.

The inherent speed of single time of flight mass spectrometry (ToF-MS) experiments is orders of magnitude faster than trapping experiments, such as CDMS, so even with the restriction of analysing one ion per experiment, significant improvement to sample analysis time is expected. Furthermore, in time of flight mass spectrometry (ToF-MS), ions follow a unique flight path and/or trajectory meaning that multiple ions can be analysed in the same time of flight mass spectrometry (ToF-MS) experiment, provided that the signals from different ions can be differentiated at the detector.

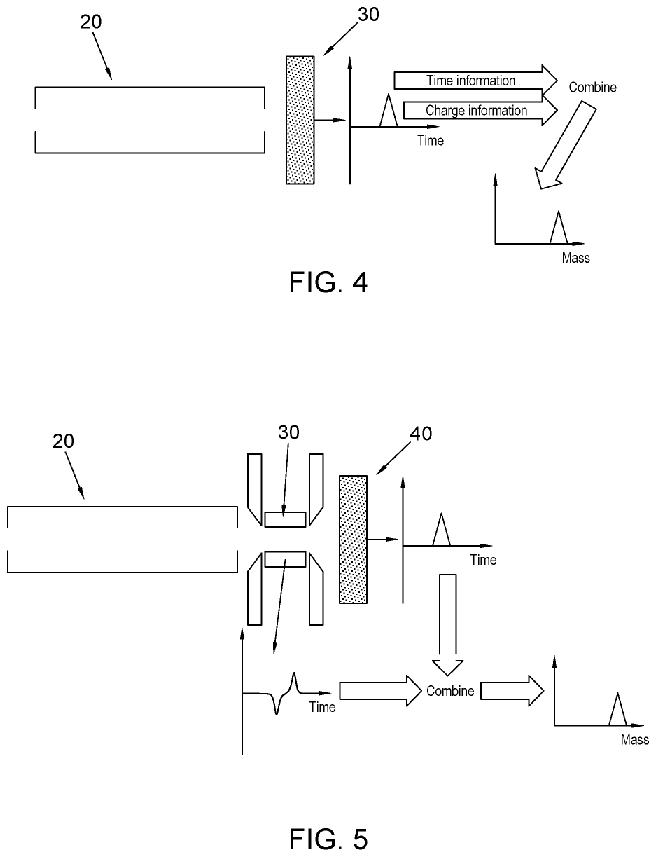

FIG. 4 shows schematically an analytical instrument configured in accordance with embodiments. As shown in FIG. 4, the analytical instrument comprises a temporal ion separation device 20 such as a ToF mass analyser, and an ion detector 30 located downstream of the ion separation device 20. The ion separation device 20 is configured to separate ions according to a first physico-chemical property such as m/z when the ions are passed through the ion separation device.

The ion detector 30 comprises a charge-resolving ion detector configured to detect an ion, so as to determine the charge of the ion. Additionally, the detector 30 is configured to measure the drift time of the ion, so as to determine the transit time for the ion. For example, the single detector 30 may have a charge dependent characteristic, and may be configured to output a signal from which the charge of the ion may be determined and from which the transit time of the ion may be measured.

In various embodiments, the charge of the ion may be determined from the area of the signal output from the detector 30 and the drift time for the ion may be determined by the weighted average of the signal.

As shown in FIG. 4, the transit time and the charge of the ion are combined to determine a second physico-chemical property, such as mass, of the ion. This occurs before the data from the ion is summed with data from other ions across multiple separations and/or binned into a histogram or spectrum. For example, if the charge state of a detected ion is linear with the area of the signal from the detector 30, then the product of the transit time and the area of the signal may be determined, and binned into a histogram. Example detectors for which the charge state is linear with the signal include faraday cups and inductive “listening” electrodes. Also superconducting tunnel junction (STJ) detectors exhibit this property.

FIG. 5 shows schematically an analytical instrument configured in accordance with an alternative embodiment. The analytical instrument comprises a temporal ion separation device 20 (which may be configured as described above), a first detector 30 and second detector 40 located downstream of the ion separation device 20.

The first detector 30 comprises a charge-resolving ion detector configured to measure or determine the charge state of an ion. The second detector 40 is configured to measure or determine the time or flight or arrival time for the ion.

As shown in FIG. 5, the time or flight or arrival time and the charge state of the ion are combined to determine a second physico-chemical property of the ion, such as mass. This is done before the data for the ion is summed with data from other ions across multiple separations and/or binned into a histogram (spectrum).

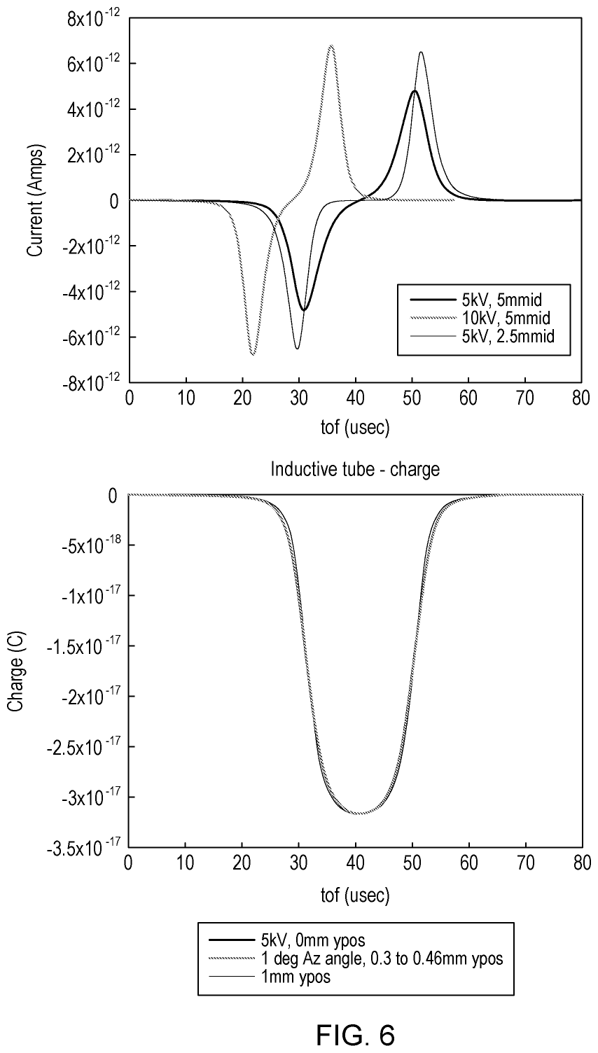

FIG. 6 shows simulated data from a simple listening tube. Particles with a mass of 4 MDa and 200 charges were accelerated with 5 kV, and passed through the tube. The tube had a 5 mm inner diameter and a length of 10 mm. The resulting induced charge and associated current are illustrated in FIG. 6.

As shown in FIG. 6, the simulations indicate that individual charge state resolution is possible with an approach as described herein. For example, assuming that the response is linear with charge, the spread in total induced charge considering ions with no divergence entering the tube on axis or offset by 1 mm equates to about 2/3 of a charge state.

Various alternative embodiments are possible.

For example, in various embodiments, the charge of the ions may be reduced prior to entering the ion separation device 20. This may be done (i) in order to charge reduce ions to the point where charge state peaks can be distinguished, (ii) in order to increase the m/z and thus amplify the velocity relaxation effect, and/or (iii) such that the percentage charge differences between unresolved charge states are increased to the point where they can be distinguished by a low-charge-resolution detector.

Charge reduction may be induced by any suitable technique(s), such as for example solution additives (charge reducing agents and/or charge reducing surfactants), and/or reactant vapours (comprising either neutral and/or ionised molecules). Evaporation of solution additives may also result in the formation of suitable reactant vapours.

Although various particular embodiments have been described in terms of T-wave mass to charge ratio separation, other separation or filtering devices exploiting time-dependent electric fields in gas-filled cells may be employed, e.g. where at least part of the ion motion exhibits significant velocity relaxation. Thus, for example, the ion separation device 20 may comprise an ion trap and/or sector device optionally driven by a substantially pulsed electric field, such as for example a 3D quadrupole ion trap, a linear ion trap, a toroidal ion trap, a pulsed electric sector filter, a parallel electrode filter, a co-axial electrode filter, and the like.

Although embodiments described above focus on time of flight mass spectrometry (ToF-MS) as the separation approach, the separations can be any time based approach such as, for example, high pressure m/z separation, scanning quadrupoles, etc.

A scanning resolving quadrupole will only let ions within a restricted mass to charge ratio (m/z) range pass at any given time, as it operates as a mass to charge ratio (m/z) filter. Varying (scanning) the mass to charge ratio (m/z) range being transmitted with time results in ions having different mass to charge ratios (m/z) arriving at the detector at different times. Where the ion detector has a charge resolving characteristic, the determined charge of each ion can be combined with the mass to charge ratio (m/z) of the ion, so as to determine the mass of each ion, i.e. in a corresponding manner to that described above.

In addition, other physico-chemical properties can benefit from the approach such as, for example, ion mobility spectrometry (IMS). In IMS ions separate in time substantially according to a cross section to charge ratio, so measuring charge and arrival time will allow overlapping mobility spectra to be converted to higher resolution cross section spectra with improved cross section measurement.

Although the simulations are shown above for a single listening device, it is recognised that significant improvements may be made by using multiple listening devices, thereby improving the precision of the charge state measurements and reducing the effects of electronic noise.

In various embodiments, characteristics of the induced charge and/or current profile may be used to calculate the mass to charge ratio (m/z) of each (individual) ion of the one or more ions. For example, referring to FIG. 5, the shape of the signal derived from the induction tube 30 can give mass to charge ratio (m/z) information. For example, the difference in time between the two (positive and negative) peaks is in effect a time of flight measurement, from which mass to charge ratio (m/z) can be determined.

Although the present invention has been described with reference to preferred embodiments, it will be understood by those skilled in the art that various changes in form and detail may be made without departing from the scope of the invention as set forth in the accompanying claims.

1. A method of analysing ions, the method comprising:
separating ions according to a first physico-chemical property by passing the ions through an ion separation device;
measuring the transit time of an ion through the ion separation device, so as to determine a transit time of the ion;
detecting the ion using a charge-resolving ion detector so as to determine a charge of the ion; and
using the transit time and the charge of the ion to determine a second physico-chemical property of the ion.

2. The method of claim 1, wherein the step of measuring the transit time of the ion through the ion separation device comprises using the charge-resolving ion detector to measure the transit time of the ion.

3. The method of any one of the preceding claims, wherein the charge-resolving ion detector comprises (i) a faraday cup or cylinder electrode detector; (ii) an electron multiplier detector; (iii) a photomultiplier or scintillation counter detector; and/or (iv) a superconducting tunnel junction (STJ) detector.

4. The method of any one of the preceding claims, wherein the method comprises determining the charge of the ion from the intensity, amplitude and/or area of a signal generated by the charge-resolving ion detector when the ion is detected.

5. The method of claim 1, wherein the step of measuring the transit time of the ion through the ion separation device comprises using a second ion detector to measure the transit time of the ion.

6. The method of claim 5, wherein the charge-resolving ion detector comprises an induction charge detector.

7. The method of claim 5 or 6, wherein the second ion detector comprises (i) a faraday cup or cylinder electrode detector; (ii) an electron multiplier detector; (iii) a photomultiplier or scintillation counter detector; and/or (iv) a superconducting tunnel junction (STJ) detector.

8. The method of any one of the preceding claims, wherein using the transit time and the charge of the ion to determine the second physico-chemical property of the ion comprises combining the transit time and the charge of the ion to determine the second physico-chemical property of the ion.

9. The method of any one of one of the preceding claims, further comprising controlling the flux of ions at the ion detector such that individual ions are distinguishable from each other when detected by the ion detector.

10. The method of any one of the preceding claims, wherein the method comprises:
for each ion of multiple ions:
measuring the transit time of the ion through the ion separation device, so as to determine a transit time of the ion;
detecting the ion using the charge-resolving ion detector so as to determine a charge of the ion; and
using the transit time and the charge of the ion to determine the second physico-chemical property of the ion; and
combining the determined second physico-chemical property of each ion of the multiple ions so as to produce a spectrum for the ions.

11. The method of any one of the preceding claims, wherein the first physico-chemical property is mass to charge ratio (m/z).

12. The method of claims 11, wherein the ion separation device comprises a time of flight (ToF) separation device configured to separate ions according to their mass to charge ratio.

13. The method of claim 11, wherein the ion separation device comprises an ion separation device in which one or more time-varying electric fields is used to urge ions through a gas such that ions are separated according to mass to charge ratio.

14. The method of claim 13, wherein the ion separation device comprises a travelling wave separation device, and wherein the method comprises successively applying one or more voltages to different electrodes of the device so as to form one or more travelling potential barriers that move along the device so as to urge ions through the separation device.

15. The method of any one of claims 1-10, wherein the first physico-chemical property is ion mobility.

16. The method of claims 15, wherein the ion separation device is an ion mobility separation device configured to separate ions according to their ion mobility.

17. A method of analysing ions, the method comprising:
detecting an ion using an induction charge detector;
determining a charge of the ion from a signal generated by the induction charge detector when the ion is detected;
determining a transit time of the ion from the signal generated by the induction charge detector when the ion is detected; and
using the transit time and the charge of the ion to determine a second physico-chemical property of the ion.

18. A method of analysing ions, the method comprising:
isolating an ion that has a first value of a first physico-chemical property by passing ions through an ion filtering device;
detecting the ion using a charge-resolving ion detector so as to determine a charge of the ion; and
using the first value of the first physico-chemical property and the charge of the ion to determine a second physico-chemical property of the ion.

19. The method of any one of the preceding claims, wherein the second physico-chemical property comprises mass.

20. The method of any one of claims 1-18, wherein the second physico-chemical property comprises collision or reaction cross section.

21. The method of any one of the preceding claims, wherein the ion and/or the ions have a mass>1 MDa.

22. An analytical instrument comprising:
an ion separation device, wherein the ion separation device is configured to separate ions according to a first physico-chemical property when the ions are passed through the ion separation device; and
an ion detector arranged downstream of the ion separation device, wherein the analytical instrument is configured such that ions eluting from the ion separation device can be detected by the ion detector;
wherein the analytical instrument is configured to measure the transit time of an ion passing through the ion separation device, so as to determine a transit time of the ion;
wherein the ion detector comprises a charge-resolving ion detector configured to determine the charge of the ion; and
wherein the analytical instrument is configured to use the transit time and the charge of the ion to determine a second physico-chemical property of the ion.
